(19) United States
(12) Patent Application Publication
(10) Pub. No.: US 2026/0158656 A1
(43) Pub. Date: Jun. 11, 2026

(54) ULTRASONIC BASED COLLISION DETECTION SYSTEM AND METHOD FOR ROBOTIC DEVICE

(71) Applicant: The Hong Kong University of Science and Technology, Hong Kong (CN)

(72) Inventors: Hongyu YU, Hong Kong (CN); Ruoqin WANG, Hong Kong (CN); Fan SHI, Hong Kong (CN); Zhengjun WANG, Hong Kong (CN)

(21) Appl. No.: 19/123,126

(22) PCT Filed: Oct. 18, 2023
(86) PCT No.: PCT/CN2023/125119

§ 371 Date: Apr. 22, 2025

Related U.S. Application Data
(60) Provisional application No. 63/423,502, filed on Nov. 8, 2022.

(51) Int. Cl. B25J 9/16; B25J 19/02; G01H 1/00

(52) U.S. Cl. CPC B25J 9/1674; B25J 19/026; G01H 1/00

(57) ABSTRACT

A method for detecting an event of collision on an outer shell of a robotic device is provided. The method includes detecting acoustic waves by a plurality of transducers mounted inside or outside the outer shell; estimating, by a processor, a position of collision on the outer shell by performing arrival time analysis on the acoustic waves detected by the plurality of transducers; determining, by the processor, an extent of collision based on intensities of the acoustic waves detected by the plurality of transducers; and performing non-destructive testing of the outer shell of the robotic device automatically after detecting the event of collision to determine a level of severity to the robotic device caused by the event of collision.

### CROSS-REFERENCE TO RELATED APPLICATIONS

This application claims the benefit of the U.S. Provisional Patent Application Ser. No. 63/423,502, filed on Nov. 8, 2022, which is incorporated by reference herein in its entirety.

### FIELD OF THE INVENTION

The present disclosure generally relates to the field of robotics. In particular, the present disclosure relates to a collision detection system and a method for detecting an event of collision for a robotic device using an ultrasonic detection technology.

### BACKGROUND OF THE INVENTION

Robots are increasingly integral to a wide range of applications for numerous industries. The robots often operates in environments where human errors, parts failures, control system failures, and other unpredictable incidents can cause deviations from the robot's trajectory or deflections of the workpiece, resulting in collisions. As industrial production evolves to incorporate more human-robot collaboration, the uncertainty related to human actions in the robot workspace magnifies the need for comprehensive safety protection systems to safeguard both workers and the robots themselves.

Any failure in detecting a collision and promptly halting the robot's movement can lead to significant damage to the robotic system, valuable tools, workpieces, and potentially pose a threat to the safety of human workers. Moreover, the process of assessing the potential damage to the robot parts post-collision often slows down the fabrication speed of the entire production line. Consequently, there is a growing need for automatic collision detection systems in industrial robots that can predict or sense collisions immediately, trigger protective measures, and estimate the extent of the collision to aid human operators in determining the need for repairs.

Currently, two prominent solutions exist in the field of robot collision sensing: contact methods and contactless methods.

Contactless methods anticipate collisions before they occur, enabling preemptive safety measures to prevent the collision. These methods employ lasers, infrared, or vision sensors to establish a “safety zone” surrounding the workspace of the robotic arm. If an unknown object enters this “safety zone,” the robotic arm slows or ceases to operate until the perceived danger is eliminated. This method offers significant safety advantages, but it may reduce the efficiency of the robot and increase the overall system cost due to the use of sensor systems. This solution is primarily employed in large, automated workshops with high degrees of automation, and it is not well-suited to complex human-robot collaboration scenarios.

Contact methods detect collisions as they happen, triggering corresponding safety measures. Unlike contactless methods that aim to prevent collisions, contact methods seek to minimize the damage resulting from post-collision impacts. These methods encompass current ring, electronic skin, and flexible joint types.

The current ring type transmits the collision torque through a spring to a set of reducers. When the torque reaches a specific level, the reducer begins to rotate, dragging the motor to generate current signals. Although this method is relatively cost-effective, it lacks precision and has a small load capacity, making it suitable only for small robotic arms.

The electronic skin type involves a pressure sensor array installed on the surface of the robotic arm to detect external forces. Despite its high sensitivity and accuracy, this method has a complex system and high costs.

The flexible joint type installs a torque sensor at the robot joint. On detecting a collision, the joint transitions from rigid to flexible, allowing the robot's end to move freely along external forces, thus reducing the damage caused by the collision. This method has a moderate cost and wider application range than other types.

In view thereof, there is a need in the art for a low-cost, efficient, and reliable solution for detecting robot collisions, which can be effectively implemented in both large-scale automated workshops and complex scenarios involving human-robot collaboration. Furthermore, other desirable features and characteristics will become apparent from the subsequent detailed description and the appended claims, taken in conjunction with the accompanying drawings and this background of the disclosure.

### SUMMARY OF THE INVENTION

Provided herein is a collision detection system and a method for detecting an event of collision for a robotic device using an ultrasonic detection technology.

According to the first aspect of the present disclosure, a method for detecting an event of collision on an outer shell of a robotic device is provided. The method includes detecting acoustic waves by a plurality of transducers mounted inside or outside the outer shell; estimating, by a processor, a position of collision on the outer shell by performing arrival time analysis on the acoustic waves detected by the plurality of transducers; determining, by the processor, an extent of collision based on intensities of the acoustic waves detected by the plurality of transducers; and performing non-destructive testing of the outer shell of the robotic device automatically after detecting the event of collision to determine a level of severity to the robotic device caused by the event of collision.

In an embodiment, the method further includes the step of transmitting, by each of the plurality of transducers, response pulses to the processor when the acoustic waves are detected by each of the plurality of transducers.

In an embodiment, the step of estimating the position of collision on the outer shell by performing arrival time analysis further includes determining, by the processor, time differences in receiving the response pulses from each of the plurality of transducers with respect to the event of collision for calculating distances from the position of collision to each of the plurality of transducers; and locating the position of collision on the outer shell based on the distances from each of the plurality of transducers.

In an embodiment, the response pulse has a signal amplitude defined by the intensities of the acoustic waves detected by the plurality of transducers; and wherein the processor is configured to calculate the extent of collision using the signal amplitudes of the response pulses collectively.

In an embodiment, the step of transmitting response pulses to the processor further includes transmitting, from time to time, electrical signals to the processor by wired or wireless communication, wherein the processor is configured to process the electrical signals to obtain the response pulses from each of the plurality of transducers.

In an embodiment, the plurality of transducers are distributed spatially across the outer shell to monitor the robotic device for detecting the acoustic waves.

In an embodiment, the plurality of transducers include a plurality of ultrasonic transducers for detecting the acoustic waves in a range of ultrasonic frequencies.

In an embodiment, the plurality of ultrasonic transducers are selected from the group consisting of piezoelectric transducers (PZT), piezoelectric polyvinylidene fluoride (PVDF) transducers, acoustic sensors, capacitive micromachined ultrasonic transducers (CMUT), and piezoelectric micromachined ultrasonic transducers (PMUT).

In an embodiment, the method further includes suspending the robotic device from operation instantaneously when the acoustic waves are detected by at least one of the plurality of transducers for minimizing damage to the robotic device and injury to individuals caused by the event of collision.

In an embodiment, the step of performing the non-destructive testing of the outer shell of the robotic device further includes acquiring, by the plurality of transducers, acoustic wave characteristics after the event of collision; and comparing, by the processor, the acoustic wave characteristics with previous data acquired before the event of collision for determining the level of severity to the robotic device caused by the event of collision.

According to the second aspect of the present disclosure, a collision detection system for detecting an event of collision for a robotic device having an outer shell is disclosed. The collision detection system includes a plurality of transducers mounted inside or outside the outer shell for detecting acoustic waves; and a processor configured to execute a method for determining whether the event of collision is happened on the outer shell, wherein the method includes the steps of performing arrival time analysis on the acoustic waves detected for determining a position of collision; performing signal analysis on the acoustic waves detected for determining an extent of collision; and performing non-destructive testing of the outer shell of the robotic device automatically after detecting the event of collision to determine a level of severity to the robotic device caused by the event of collision.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Other aspects and advantages of the present invention are disclosed as illustrated by the embodiments hereinafter.

### BRIEF DESCRIPTION OF THE DRAWINGS

The appended drawings contain figures to further illustrate and clarify the above and other aspects, advantages, and features of the present disclosure. It will be appreciated that these drawings depict only certain embodiments of the present disclosure and are not intended to limit its scope. It will also be appreciated that these drawings are illustrated for simplicity and clarity and have not necessarily been depicted to scale. The present disclosure will now be described and explained with additional specificity and detail through the use of the accompanying drawings in which:

FIG. 1 is a robotic device having a collision detection system in accordance with certain embodiments of the present disclosure.

FIG. 2 is a photo of the outer shell surrounding the robotic device in accordance with certain embodiments of the present disclosure.

FIG. 3 is an internal view of the robotic device of FIG. 2 having a plurality of transducers for collision detection.

FIG. 4 is a graph showing the collision locating error.

### DETAILED DESCRIPTION OF THE INVENTION

The following detailed description is merely exemplary in nature and is not intended to limit the disclosure or its application and/or uses. It should be appreciated that a vast number of variations exist. The detailed description will enable those of ordinary skilled in the art to implement an exemplary embodiment of the present disclosure without undue experimentation, and it is understood that various changes or modifications may be made in the function and structure described in the exemplary embodiment without departing from the scope of the present disclosure as set forth in the appended claims.

The benefits, advantages, solutions to problems, and any element(s) that may cause any benefit, advantage, or solution to occur or become more pronounced are not to be construed as a critical, required, or essential features or elements of any or all of the claims. The invention is defined solely by the appended claims including any amendments made during the pendency of this application and all equivalents of those claims as issued.

The term “processor”, as used herein, generally refers to all types of digital processing devices, including, without limitation, a microcontroller unit, a custom integrated circuit, digital signal processors, a field-programmable gate array, application-specific integrated circuits, a central processing unit, a graphics processing unit, a computer device, a programmable I/O device, other semiconductor devices, or any combination thereof.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The terms “comprising,” “having,” and “including” or any other variation thereof, are to be construed as open-ended terms (i.e., meaning “including, but not limited to,”) unless otherwise noted. The use of any and all examples, or exemplary language (e.g., “such as”) provided herein, is intended merely to illuminate the invention better and does not pose a limitation on the scope of the invention unless otherwise claimed. No language in the specification should be construed as indicating any non-claimed element as essential to the practice of the invention.

Unless otherwise defined, all terms (including technical and scientific terms) used in the embodiments of the present invention have the same meaning as commonly understood by an ordinary skilled person in the art to which the present invention belongs.

In light of the background, it is desirable to have a collision detection system for a robotic device. Particularly, the collision detection system is a low-cost, efficient, and reliable system for detecting robot collisions. It can be effectively implemented in both large-scale automated workshops and complex scenarios involving human-robot collaboration.

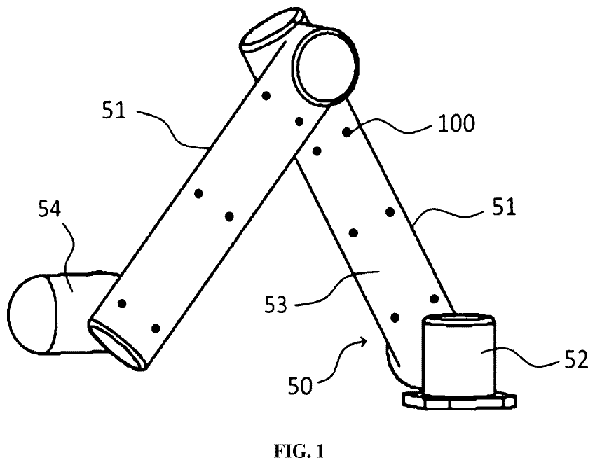

The present disclosure is related to a collision detection system and a method capable of detecting an event of collision for a robotic device. FIG. 1 shows a robotic device 50 having a collision detection system according to an embodiment of the present invention. The robotic device 50 comprises one or more moveable elements 51, an immovable element 52, and an outer shell 53 at least partially surrounding the one or more moveable elements 51. FIG. 2 shows an exemplary outer shell 53 surrounding the robotic device 50. In certain embodiments, the outer shell 53 may also surround the immovable element 52. As shown in the illustrated embodiments of FIG. 1, the robotic device 50 is a robotic arm for controlling the physical position and the orientation of the head portion 54. The head portion 54 may include functional device capable of performing one or more tasks.

Generally, the robotic device 50 is complex with various mechanical and electronic devices inside. The available space for mounting sensors is limited, and it is necessary to use sensors that are small enough for the robotic device 50, and can be installed easily without taking up too much space and effort.

In certain embodiments, the collision detection system includes a plurality of transducers 100 mounted inside or outside the outer shell 53 for detecting acoustic waves. The term “acoustic wave” does not indicate a particular frequency of wave, and preferably the acoustic wave is an ultrasonic wave in a range of ultrasonic frequencies. Therefore, the present disclosure is fundamentally supported by the ultrasonic detection technology. When there is an event of collision, the acoustic wave generated from the event of collision would propagate through the outer shell 53. For example, when the one or more moveable elements 51 collide with an individual, the contact on the outer shell 53 would generate an acoustic wave to all directions. The acoustic waves, particularly the ultrasonic waves, transmit very fast in a solid material like metal or composite material that is commonly used as the outer shell 53 of the robotic device 50. So, after the collision occurs, the plurality of transducers 100 can detect the collision within a few milliseconds. As an example, the wave velocity is around 5 km/s in Aluminum plate and the response time can be around 0.02 ms.

As it is provided that the acoustic wave may be an ultrasonic wave, the plurality of transducers 100 may include a plurality of ultrasonic transducers for detecting the acoustic waves in the range of ultrasonic frequencies. In certain embodiments, the plurality of ultrasonic transducers are selected from the group consisting of piezoelectric transducers (PZT), piezoelectric polyvinylidene fluoride (PVDF) transducers, acoustic sensors, capacitive micromachined ultrasonic transducers (CMUT), piezoelectric micromachined ultrasonic transducers (PMUT), and other types of ultrasonic transducers. For those conventional collision sensors, the cost is relatively high. For example, the most common flexible joints usually cost thousands of dollars and cannot be widely applied in the industry. In accordance with the present disclosure, the use of ultrasonic transducers is inexpensive to install, and the ultrasonic sensors are readily available in the market. Each individual transducer only costs less than $1 USD.

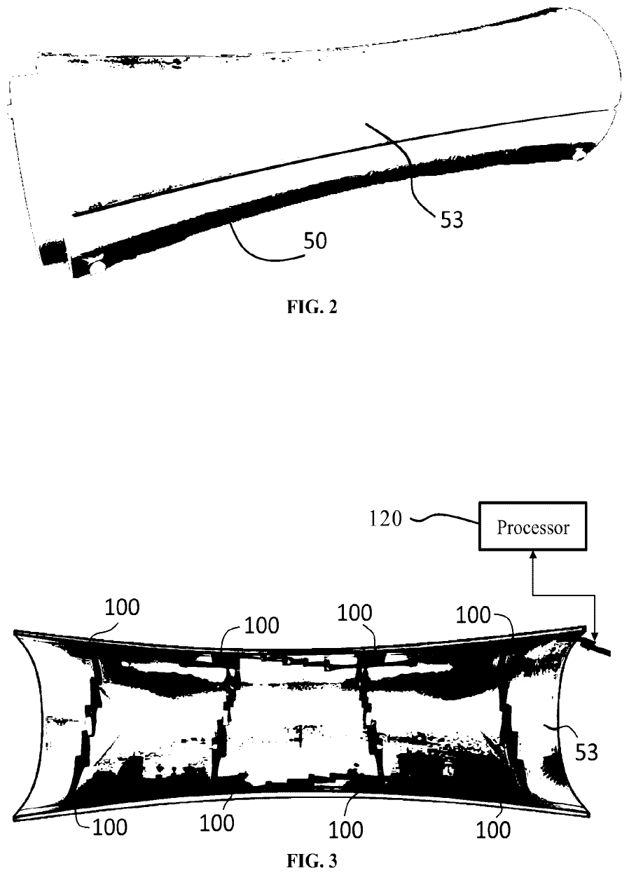

The plurality of transducers 100 are required to be in contact with the outer shell 53, but there is no limitation on whether the plurality of transducers 100 should be mounted inside or outside the outer shell 53. The locations of the plurality of transducers 100 are determined to cover the entire surface of the outer shell 53 for estimating the location of collision easily. Preferably, the plurality of transducers 100 are evenly mounted inside or outside the outer shell 53 and distributed spatially across the outer shell 53 in a predefined pattern to monitor the robotic device 50 for detecting the acoustic waves. FIG. 3 shows an internal view of the robotic device 50 having a plurality of transducers 100 mounted inside the outer shell 53 for collision detection. The example provides 8 ultrasonic transducers mounted on a 30 cm-long curved outer shell 53 of Aluminum.

The collision detection system further includes a processor 120 configured to execute a method for determining whether the event of collision is happened on the outer shell 53. When the acoustic waves are detected by any one of the plurality of transducers 100, that transducer would transmit response pulses to the processor 120. In certain embodiments, the plurality of transducers 100 are configured to transmit, from time to time, electrical signals to the processor 120 by wired or wireless communication. For the case of wireless communication, the plurality of transducers 100 are electrically connected to one or more wireless transmitters, such as Bluetooth transceivers, Wi-Fi transceivers, Zigbee transceivers, and/or other similar types of wireless transceivers configured to communicate over a wireless network.

The processor 120 is configured to process the electrical signals to obtain the response pulses from each of the plurality of transducers 100. The present disclosure advantageously provides that the response pulses from the plurality of transducers 100 are evaluated by the processor 120 to determine a position of collision and an extent of collision. In the preferred embodiment, the processor 120 is configured to perform arrival time analysis on the acoustic waves detected for determining the position of collision; and perform signal analysis on the acoustic waves detected for determining the extent of collision.

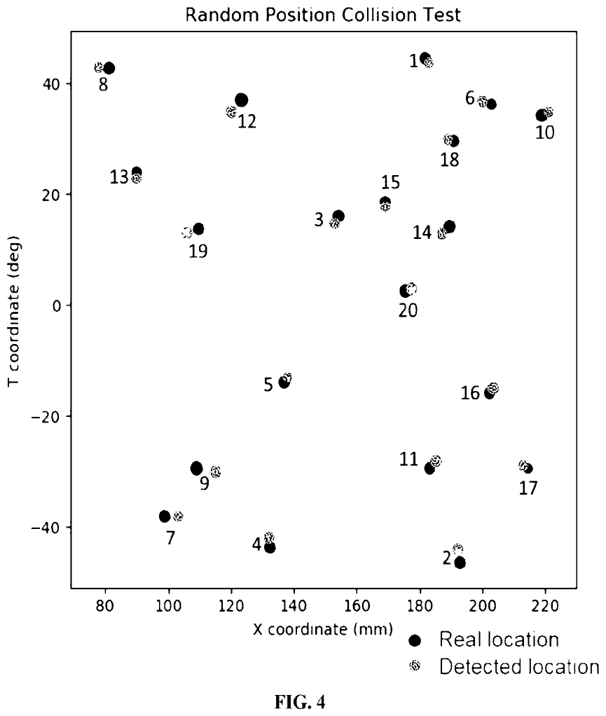

As for the position of collision, the distances between the point of collision and each of the plurality of transducers 100 are different. When the collision occurs, the acoustic waves need different times to arrive at each of the plurality of transducers 100. By calculating the time differences in detecting the acoustic waves between each of the plurality of transducers 100, the position of collision can be located based on the arrival time analysis. Therefore, the processor is configured to determine the time differences in receiving the response pulses from each of the plurality of transducers 100 with respect to the event of collision for calculating the distances from the position of collision to each of the plurality of transducers 100. Based on the distance calculated, the position of collision can be located. FIG. 4 provides a graph showing the collision locating error, which are all less than 5 mm.

As for the extent of collision, different collision forces or torques will produce different intensities of acoustic waves. The extent of collision can be evaluated through the signal analysis on the acoustic waves detected by the plurality of transducers 100. When the collision force is strong, the acoustic waves have a higher intensity and can be detected accordingly by the plurality of transducers 100. Based on the detected acoustic waves, the plurality of transducers 100 transmits response pulses of different signal amplitudes. Therefore, the response pulse has a signal amplitude defined by the intensities of the acoustic waves detected by the plurality of transducers 100, which is transmitted to the processor 120 for calculating the extent of collision. The signal amplitudes from the plurality of transducers 100 are evaluated collectively, and each corresponding distance from the position of collision is also considered for determining the extent of collision.

Another aspect of the present disclosure provides that non-destructive testing are performed after the event of collision is detected. The processor 120 is configured to perform non-destructive testing of the outer shell 53 of the robotic device 50 automatically to determine a level of severity to the robotic device 50 caused by the event of collision. If there is damage on the structure, this can be found by analyzing the acoustic waves detected by each of the plurality of transducers 100. With the non-destructive testing, the robotic device 50 can obtain a preliminary testing result about how severe the collision is before human operator comes on site. Particularly, the non-destructive testing of the outer shell 53 includes acquiring, by the plurality of transducers 100, acoustic wave characteristics after the event of collision; and comparing, by the processor 120, the acoustic wave characteristics with previous data acquired before the event of collision for determining the level of severity to the robotic device 50 caused by the event of collision. The non-destructive testing can be completed within a few minutes. If there are no damage to the robotic device 50, it can be returned to work immediately. If the level of severity is determined to be high, the processor 120 is configured to notice the human operator to come and evaluate how severe the damage is and what actions need to be done to fix the robotic device 50.

In certain embodiments, the processor 120 is configured to instantaneously suspend the robotic device 50 from operation when the acoustic waves are detected by at least one of the plurality of transducers 100 for minimizing damage to the robotic device 50 and injury to individuals caused by the event of collision. As the ultrasonic waves transmit very fast, the collision can be detected by any one of the plurality of transducers 100 within a few milliseconds. The mechanical of suspending the robotic device 50 instantaneously can protect the robotic device 50 from further damage. If the collision involves an individual, the suspension can also minimize the injury caused.

In the illustrated embodiments, the robotic device 50 is a robotic arm and the test is limited to certain movements. However, it is apparent that the collision detection system may be applied to other larger robotic systems and humanoid robots without departing from the scope and spirit of the present disclosure. Therefore, the collision detection system can achieve a full body collision sensing ability.

This illustrates the collision detection system and the method for detecting an event of collision for a robotic device 50 using an ultrasonic detection technology in accordance with the present disclosure. It will be apparent that variants of the above-disclosed and other features and functions, or alternatives thereof, may be integrated into humanoid robots or other automation systems. The present embodiment is, therefore, to be considered in all respects as illustrative and not restrictive. The scope of the disclosure is indicated by the appended claims rather than by the preceding description, and all changes that come within the meaning and range of equivalency of the claims are therefore intended to be embraced therein.

What is claimed is:

1. A method for detecting an event of collision on an outer shell of a robotic device, comprising:
detecting acoustic waves by a plurality of transducers mounted inside or outside the outer shell;
estimating, by a processor, a position of collision on the outer shell by performing arrival time analysis on the acoustic waves detected by the plurality of transducers;
determining, by the processor, an extent of collision based on intensities of the acoustic waves detected by the plurality of transducers; and
performing non-destructive testing of the outer shell of the robotic device automatically after detecting the event of collision to determine a level of severity to the robotic device caused by the event of collision.

2. The method of claim 1 further comprising the step of transmitting, by each of the plurality of transducers, response pulses to the processor when the acoustic waves are detected by each of the plurality of transducers.

3. The method of claim 2, wherein the step of estimating the position of collision on the outer shell by performing arrival time analysis further comprises:
determining, by the processor, time differences in receiving the response pulses from each of the plurality of transducers with respect to the event of collision for calculating distances from the position of collision to each of the plurality of transducers; and
locating the position of collision on the outer shell based on the distances from each of the plurality of transducers.

4. The method of claim 2, wherein the response pulse has a signal amplitude defined by the intensities of the acoustic waves detected by the plurality of transducers; and wherein the processor is configured to calculate the extent of collision using the signal amplitudes of the response pulses collectively.

5. The method of claim 2, wherein the step of transmitting response pulses to the processor further comprises transmitting, from time to time, electrical signals to the processor by wired or wireless communication, wherein the processor is configured to process the electrical signals to obtain the response pulses from each of the plurality of transducers.

6. The method of claim 1, wherein the plurality of transducers are distributed spatially across the outer shell to monitor the robotic device for detecting the acoustic waves.

7. The method of claim 6, wherein the plurality of transducers comprise a plurality of ultrasonic transducers for detecting the acoustic waves in a range of ultrasonic frequencies.

8. The method of claim 7, wherein the plurality of ultrasonic transducers are selected from the group consisting of piezoelectric transducers (PZT), piezoelectric polyvinylidene fluoride (PVDF) transducers, acoustic sensors, capacitive micromachined ultrasonic transducers (CMUT), and piezoelectric micromachined ultrasonic transducers (PMUT).

9. The method of claim 1 further comprising suspending the robotic device from operation instantaneously when the acoustic waves are detected by at least one of the plurality of transducers for minimizing damage to the robotic device and injury to individuals caused by the event of collision.

10. The method of claim 1, wherein the step of performing the non-destructive testing of the outer shell of the robotic device further comprises:
acquiring, by the plurality of transducers, acoustic wave characteristics after the event of collision; and
comparing, by the processor, the acoustic wave characteristics with previous data acquired before the event of collision for determining the level of severity to the robotic device caused by the event of collision.

11. A collision detection system for detecting an event of collision for a robotic device having an outer shell, comprising:
a plurality of transducers mounted inside or outside the outer shell for detecting acoustic waves; and
a processor configured to execute a method for determining whether the event of collision is happened on the outer shell, wherein the method comprises the steps of:
performing arrival time analysis on the acoustic waves detected for determining a position of collision;
performing signal analysis on the acoustic waves detected for determining an extent of collision; and
performing non-destructive testing of the outer shell of the robotic device automatically after detecting the event of collision to determine a level of severity to the robotic device caused by the event of collision.

12. The collision detection system of claim 11, wherein each of the plurality of transducers transmits response pulses to the processor when the acoustic waves are detected.

13. The collision detection system of claim 12, wherein the step of performing arrival time analysis further comprises:
determining time differences in receiving the response pulses from each of the plurality of transducers with respect to the event of collision for calculating distances from the position of collision to each of the plurality of transducers; and
locating the position of collision on the outer shell based on the distances from each of the plurality of transducers.

14. The collision detection system of claim 12, wherein the response pulse has a signal amplitude defined by the intensities of the acoustic waves detected by the plurality of transducers; and wherein the processor is configured to calculate the extent of collision using the signal amplitudes of the response pulses collectively.

15. The collision detection system of claim 12, wherein the plurality of transducers are configured to transmit, from time to time, electrical signals to the processor by wired or wireless communication; and wherein the processor is configured to process the electrical signals to obtain the response pulses from each of the plurality of transducers.

16. The collision detection system of claim 11, wherein the plurality of transducers are distributed spatially across the outer shell to monitor the robotic device for detecting the acoustic waves.

17. The collision detection system of claim 16, wherein the plurality of transducers comprise a plurality of ultrasonic transducers for detecting the acoustic waves in a range of ultrasonic frequencies.

18. The collision detection system of claim 17, wherein the plurality of ultrasonic transducers are selected from the group consisting of piezoelectric transducers (PZT), piezoelectric polyvinylidene fluoride (PVDF) transducers, acoustic sensors, capacitive micromachined ultrasonic transducers (CMUT), and piezoelectric micromachined ultrasonic transducers (PMUT).

19. The collision detection system of claim 1, wherein the processor is configured to instantaneously suspend the robotic device from operation when the acoustic waves are detected by at least one of the plurality of transducers for minimizing damage to the robotic device and injury to individuals caused by the event of collision.

20. The collision detection system of claim 1, wherein the step of performing the non-destructive testing of the outer shell of the robotic device further comprises:
acquiring, by the plurality of transducers, acoustic wave characteristics after the event of collision; and
comparing, by the processor, the acoustic wave characteristics with previous data acquired before the event of collision for determining the level of severity to the robotic device caused by the event of collision.
